(19) United States
(12) Patent Application Publication
(10) Pub. No.: US 2026/0314559 A1
(43) Pub. Date: Oct. 15, 2026

(54) FEED AND WATERING TRAY FOR USE IN DISPOSABLE ANIMAL CAGING

(71) Applicant: Allentown, LLC, Allentown, NJ (US)

(72) Inventor: Steven J. Miller, Cream Ridge, NJ (US)

(73) Assignee: Allentown, LLC, Allentown, NJ (US)

(21) Appl. No.: 19/643,131

(22) Filed: Apr. 9, 2026

Related U.S. Application Data
(60) Provisional application No. 63/785,859, filed on Apr. 9, 2025.

(51) Int. Cl. A01K 1/035; A01K 5/01; A01K 7/00

(52) U.S. Cl. CPC A01K 1/0356; A01K 5/0114; A01K 7/00

(57) ABSTRACT

An intra-cage feed and watering tray in which any corner or edge present in the feed and watering tray for use with a bottle or bag, that is accessible to a rodent when the animal cage is in a closed position is defined by surfaces having a pre-determined radius in order to prevent gnawing of the feed and watering tray. The feed and watering tray can be used in a disposable animal cage used in a ventilated or static caging rack system.

### BACKGROUND OF THE INVENTION

### Field of the Invention

The present invention relates to an intra-cage feed and watering tray in which any corner or edge present in the feed and watering tray that is accessible to a rodent is defined by surfaces having a pre-determined radius in order to prevent gnawing of the feed and watering tray. The feed and watering tray can receive a bottle or bag of water and can be used in a disposable animal cage used in a ventilated or static caging rack system.

### Description of Related Art

U.S. Pat. No. 6,308,660 describes an animal caging system including a self-sealing or filtered opening animal cage removably connected to an air supply and an exhaust. The self-sealing or filtered opening animal cage is supported by a rack. The self-sealing or filtered opening animal cage is sealed by an air inlet connection and an air outlet connection to the air supply and the exhaust connection. After the cages are removed from the air supply and the exhaust, the air inlet connection and the exhaust connection seals the cage or has a filter media applied to the cage and top to prevent air from entering or exiting the cage.

The air supply and exhaust are provided with an air delivery and exhaust apparatus. The air delivery and exhaust apparatus is integrated with high efficiency particulate air (HEPA) filters. The air delivery and exhaust apparatus operates in a positive pressure mode for pushing air into the cage or in a negative mode for withdrawing air from the cage. Air from the environment is HEPA filtered and is used as supply air in the air delivery apparatus and exhaust air from the exhaust apparatus is HEPA filtered before being emitted into the environment. The animal caging system provides isolation of the animal cage and provides containment of airborne pathogens within the caging system.

Animal containment systems that comprise disposable, single-use components, which do not require washing and sterilization for re-use are known. U.S. Pat. No. 9,265,229 describes a single use cage preventing gnawing damage to the thin-walled cage by including a geometric guidelines for the interior corners of the cage.

It is desirable to provide an improved geometric design of a feed and watering tray for use in a disposable animal cage which prevents animals from gnawing on the tray surfaces and having low manufacturing costs.

### BRIEF SUMMARY OF THE INVENTION

The present invention relates to an intra-cage feed and watering tray to prevent animal chewing. The feed and watering tray can be disposable. The feed and watering tray can receive and house a bottle or bag of water within an animal cage. In particular, the present invention relates to a feed and watering tray for use in a disposable animal cage. The disposable animal cage can be used in a ventilated or static caging rack system. The disposable animal cage can be a free-standing cage assembly constructed of a cage base and a cage top. The feed and watering tray is supported by the cage base and positioned below the cage top. Alternatively, the feed and watering tray can be reusable and can be used in a reusable cage or disposable cage. The disposable animal cage or reusable cage can be used with rodent animals including mice and rats or similar sized species.

The feed and watering tray can include a feed section and a water section. A top of one side of the feed section is coupled or integral to a top of one side of the water section. The feed section can include side walls angled toward feed apertures formed in a bottom of the feed section. The water section can include side walls angled to an aperture formed in a bottom of the water section. The water section is configured to receive a bottle or bag of water. All corners and edges of the feed and watering tray have a radius of 0.125 or greater to prevent animal chewing of the feed and watering tray. The walls of the feed and watering tray can have a thickness in the range of about 0.01 to 0.125 inches. The thickness of the feed and watering tray has the advantage of providing low manufacturing costs due to a reduction in the amount of material needed to form the feed and watering tray. The feed and watering tray can be formed of a transparent or clear material. The material of the feed and watering tray allows for vision of animals within the cage through the feed and watering tray. For example, the feed and watering tray can be formed of plastic.

A flange extending from an edge of the feed section and a flange extending from an edge of the water section can be received in a respective depression of the cage base for removably attaching the feed and watering tray to the cage base. The feed and watering tray can be disposed beneath an air filter of the cage top of the animal cage. The feed and watering tray location within the animal cage provides protection of the filter from being gnawed or punctured and prevents escape of the animals from the animal cage.

The cage base comprises walls extending from a floor. The walls can be integral with the floor. The cage top comprises walls extending from a ceiling or a flat top. The cage base and the cage top can be constructed of a polymer. The material forming the cage can be transparent or clear. Any or all walls and the floor of the cage base can have a material thickness between about 0.005 inches to about 0.125 inches. Any or all walls of the cage top can have a material thickness between about 0.005 inches to about 0.125 inches.

The cage base and cage top can be snap fitted to one another. A top edge of the cage base extending from the cage base creates a suspended runner system allowing the animal cage to be installed on rows of a ventilated rack or a static air rack to automatically lock the cage top and cage base together.

The invention will be more fully described by reference to the following drawings.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a top and front perspective view of a feed and watering tray;

FIG. 2 is a bottom and front view of the feed and watering tray;

FIG. 3 is a rear view of the feed and watering tray housing a water bag;

FIG. 4 is a rear view of the feed and watering tray housing a water bottle;

FIG. 5 s perspective view of the feed and watering tray received in a base of an animal cage; and

FIG. 6 is perspective view of the animal cage after receiving a cage top.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

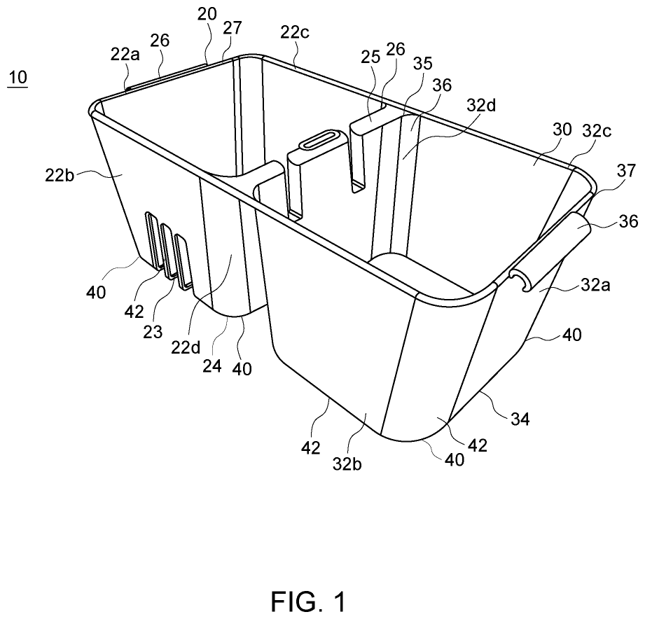

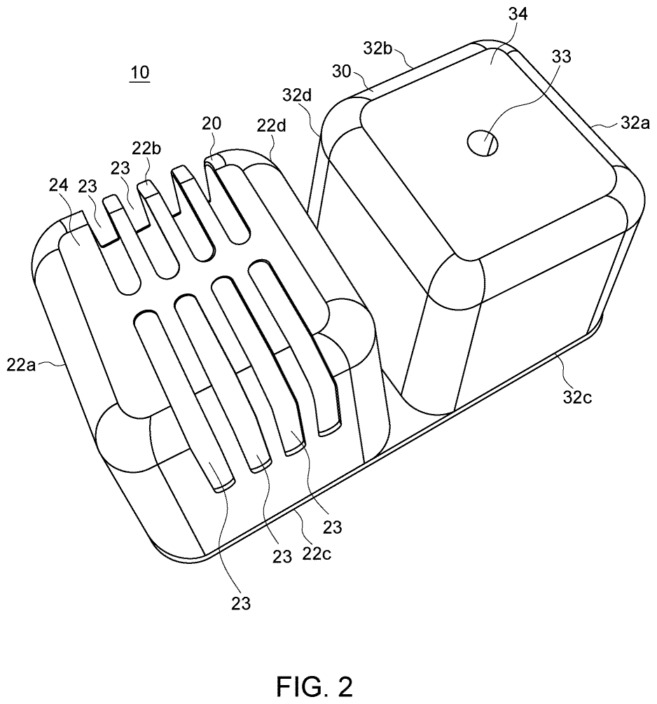

FIGS. 1 and 2 illustrate feed and watering tray 10 in accordance with the teachings of the present invention. Feed and watering tray 10 includes feed section 20 and water section 30. Side walls 22a-d of feed section 20 are angled toward one or more feed openings 23 formed in bottom 24 of feed section 20. Side walls 32a-32d of water section 30 are angled to aperture 33 formed in bottom 34 of water section 30. Side walls 22a-22d and bottom 24 of feed section 20 can have a thickness in the range of about 0.01 to about 0.125 inches. Side walls 32 a-32d and bottom 34 of water section 30 can have a thickness in the range of about 0.01 to about 0.125 inches. Top edge 25 of side wall 22d positioned at interior 26 of feed section 20 is coupled or integral to top edge 35 of side wall 32d positioned at interior 36 of water section 30 of one side of the water section. Corners 40 are formed between adjacent respective sidewalls 22a-d and bottom 24 of feed section 20. Corners 40 are formed between adjacent respective sidewalls 32a-32d and bottom 34 of water section 30. Edges 42 are formed between adjacent respective side walls 22a-d of feed section 20. Edges 42 are formed between adjacent respective side walls 32a-32d of water section 30. All corners 40 and edges 42 of the feed and watering tray 10 have a radius of about 0.125 inches or greater to prevent animal chewing of feed and watering tray 10.

Feed and watering tray 10 can be formed of a transparent or clear material. For example, feed and watering tray 10 can be formed of plastic. Suitable materials for feed and watering tray 10 include Polycarbonate (PC), low density polyethylene (LDPE) and polypropylene (PP), high density polyethylene (HDPE) or equivalent transparent materials.

Flange 26 extends from top edge 27 of side wall 22a of feed section 20. Side wall 22a is positioned at an exterior of feed section 20. Flange 36 extends from top edge 37 of a side wall 32a of water section 30. Side wall 22a is positioned at an exterior of feed section 20.

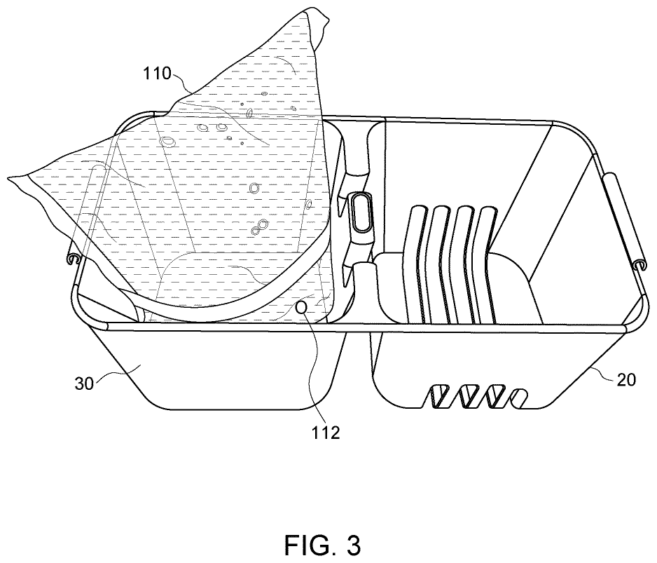

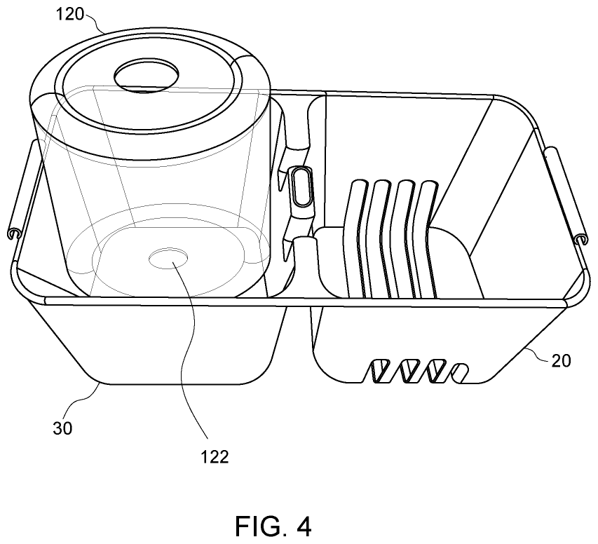

Water section 30 is configured to removably house bag 110 of water having spout 112 which can extend through aperture 33 formed in bottom 34 of water section 30 as shown in FIG. 3. Water section 30 is configured to removably house bottle 120 of water having spout 122 which can extend through aperture 33 formed in bottom 34 of water section 30 as shown in FIG. 4.

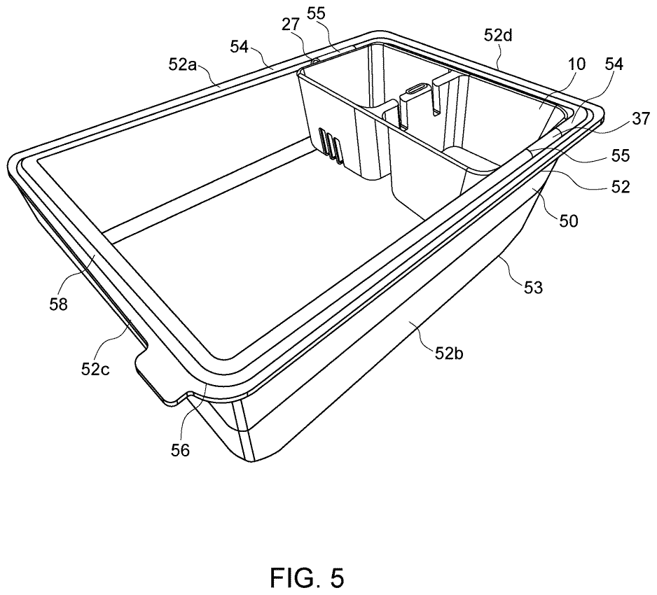

FIG. 5 illustrates feed and watering tray 10 removably received and supported on cage base 50. Water section 20 and feed section 30 extend into cage base 50. Cage base 50 includes walls 52 extending from floor 53. Walls 52 and floor 53 can be integral to one another. Walls 52 can include side walls 52a and 52b on either side of cage base 50. Walls 52 can include front wall 52c and rear wall 52d. Flange 26 can be received over top edge 54 of side walls 52a. Flange 36 can be received over top edge 54 of side wall 52b. In one embodiment, walls 52a and 52b can include depressions 55 in top edge 54. Flange 26 and flange 36 can be received in depressions 55 of top edge 54. Side flange 56 of cage base 50 extends laterally circumferentially from cage base 50. Side flange 56 of cage base 50 extending from cage base 50 can be received within a suspended runner system not shown.

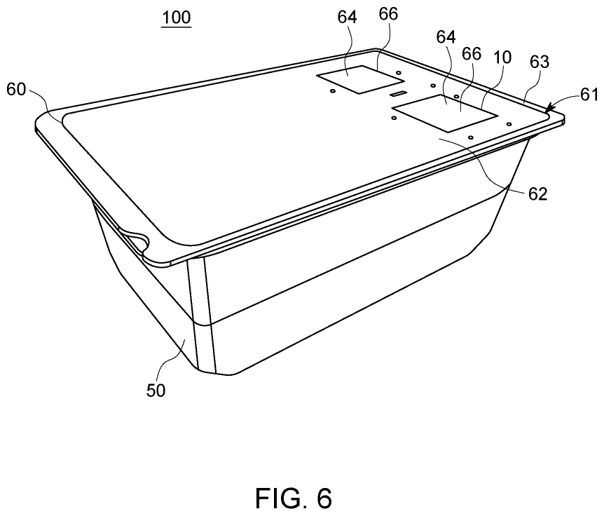

Walls 52 of cage base 50 support cage top 60 on top edge 54 as shown in FIG. 6. Cage base 50 and cage top 60 can be snap fitted to one another to form animal cage 61. Animal cage 61 can be a disposable animal cage. Feed and watering tray 10 is positioned beneath cage top 60 to house a bag of water or bottle within animal cage 61. Cage top 60 can include walls 63 extending downwardly from ceiling 62. Walls 63 and ceiling 62 can be integral to one another. Walls 63 of cage top 50 can be received in depression 58 of cage base 50 shown in FIG. 5. In the closed position of cage top 60 shown in FIG. 6, cage top 60 covers cage base 50. Cage top 60 is substantially flat in a horizontal position supported by cage base 50.

Referring to FIG. 6, one or more openings 64 can be formed in ceiling 62. One or more openings 64 can be covered by one or more filters 66. One or more openings 64 can be used to receive and emit air. Feed and watering tray 10 can be positioned below filters 66 for preventing animals contained within cage base 50 from accessing filters 66.

Feed and watering system 100 can include feed and watering tray 10, cage base 50 and cage top 60. Feed and watering tray 10 is positioned beneath cage top 60 to receive and house a bag of water or a bottle within animal cage 61. Cage top 60 closes animal cage 61. The bag of water or bottle of water within animal cage 61 is accessible to the animals when animal cage 61 is in a closed position.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A feed and watering tray comprising:
a feed section and a water section;
side walls of the feed section are angled toward one or more feed openings formed in a bottom of the feed section;
side walls of the water section are angled to an aperture formed in a bottom of the water section;
corners being formed between the sidewalls of the feed section which are adjacent to one another and the bottom of the feed section; and
corners being formed between the sidewalls of the water section and the bottom of the water section,
wherein all corners have a radius of about 0.125 inches or greater.

2. The tray of claim 1 further comprising:
edges being formed between the side walls of the feed section which are adjacent to one another; and
edges being formed between the side walls of the water section which are adjacent to one another,
wherein all edges have a radius of about 0.125 inches or greater.

3. The tray of claim 1 wherein a top edge of one of the side walls positioned at an interior of the feed section is coupled or integral to a top edge of one of the side walls positioned at an interior of the water section.

4. The tray of claim 1 wherein a first flange extends from a top edge of one of the side walls positioned at an exterior end of the feed section; and
a second flange extends from a top edge of one of the side walls positioned at an exterior end of the feed section.

5. The tray of claim 4 wherein feed the tray is configured to be removably received and supported on a cage base, the water section and the feed section extend into the received cage base, the cage base includes walls extending from a floor, the first flange being received over a top edge of one of the walls on a first side of the cage base and the second flange being received over a top edge of one of the walls on a second side of the cage base.

6. The tray of claim 5 wherein the top edge of one of the walls on a first side of the cage base has a first depression and the top edge of one of the walls on a second side of the cage base has a second depression wherein the first flange being received in the first depression and the second flange being received in the second depression.

7. The tray of claim 1 the water section is configured to removably house a bag of water having spout, the spout extending through the aperture formed in the bottom of the water section.

8. The tray of claim 1 the water section is configured to removably house a bottle of water having spout, the spout extending through the aperture formed in the bottom of the water section.

9. The tray of claim 1 wherein the sidewalls of the feed section and the sidewalls of the water section have a thickness in the range of about 0.01 to about 0.125 inches.

10. The tray of claim of claim 1 wherein in the tray is formed of a transparent or clear material.

11. The tray of claim of claim 10 wherein the tray is formed from a material selected from one or more of plastic, polycarbonate (PC), low density polyethylene (LDPE), polypropylene (PP), and high density polyethylene (HDPE).

12. A feed and watering system comprising:
a feed and watering tray, cage base and cage top;
the feed and watering tray comprising a feed section and a water section;
side walls of the feed section are angled toward one or more feed openings formed in a bottom of the feed section;
side walls of the water section are angled to an aperture formed in a bottom of the water section;
corners being formed between the sidewalls of the feed section which are adjacent to one another and the bottom of the feed section; and
corners being formed between the sidewalls of the water section and the bottom of the water section, all corners have a radius of about 0.125 inches or greater,
wherein the feed and watering tray is positioned beneath the cage top and is configured to receive and house a bag of water or a bottle within the cage base after the cage top is received over the cage base to close the cage base allowing accessibility to the bag of water or bottle of water in a closed position.

13. The system of claim 12 further comprising:
edges being formed between the side walls of the feed section which are adjacent to one another; and
edges being formed between the side walls of the water section which are adjacent to one another,
wherein all edges have a radius of about 0.125 inches or greater.

14. The system of claim 12 wherein a top edge of one of the side walls positioned at an interior of the feed section is coupled or integral to a top edge of one of the side walls positioned at an interior of the water section.

15. The system of claim 12 a first flange extends from a top edge of one of the side walls positioned at an exterior end of the feed section; and
a second flange extends from a top edge of one of the side walls positioned at an exterior end of the feed section.

16. The system of claim 15 wherein the feed and watering tray is configured to be removably received and supported on the cage base, the water section and the feed section extend into the cage base, the cage base includes walls extending from a floor, the first flange being received over a top edge of one of the walls on a first side of the cage base and the second flange being received over a top edge of one of the walls on a second side of the cage base.

17. The system of claim 16 wherein the top edge of one of the walls on a first side of the cage base has a first depression and the top edge of one of the walls on a second side of the cage base has a second depression wherein the first flange being received in the first depression and the second flange being received in the second depression.

18. The system of claim 12 wherein the water section is configured to removably house a bag of water having spout, the spout extending through the aperture formed in the bottom of the water section.

19. The system of claim 12 wherein the water section is configured to removably house a bottle of water having spout, the spout extending through the aperture formed in the bottom of the water section.

20. The system of claim 12 wherein the feed and watering tray is formed of a transparent or clear material tray and the sidewalls of the feed section and the sidewalls of the water section have a thickness in the range of about 0.01 to about 0.125 inches.
